(19) United States
(12) Patent Application Publication
(10) Pub. No.: US 2014/0352195 A1
(43) Pub. Date: Dec. 4, 2014

(54) Automatic setting of fish hooks using spring loaded fishing pole holder and related methods

(71) Applicant: Edward Peterson, Tooele, UT (US)

(72) Inventor: Edward Peterson, Tooele, UT (US)

(21) Appl. No.: 13/986,725

(22) Filed: May 29, 2013

(51) Int. Cl. A01K 97/11; A01K 97/01

(52) U.S. Cl. CPC A01K 97/11; A01K 97/01
USPC 43/15

(57) ABSTRACT

Fishing pole holders are disclosed, which automatically set a hook in the mouth of a fish directly in response to a fish bite, without human intervention, which holders are mounted on any one of several stable supports for propping a fishing pole, with all holders, supports and accessories being placed in a kit comprising a portable container or carrying case.

### FIELD OF THE INVENTION

The present invention relates generally to fishing from the shore or in a boat or above ice, using a fishing pole holder or prop and, more particularly, to base or anchor-supported fishing pole holders, each having a pole-received receptacle or receiver, the pole being retained in a cocked position counter to a bias imposed on the receiver, which is released from the cocked position due to the bite of a fish to forcibly rotate the fishing pole to set a hook in the mouth of the fish.

### BACKGROUND

While fishing, using a propped pole, is per se old, three problems have persisted. First, in the past, propped poles have required the fisherman to retrieve the pole from the prop site and, thereafter, manually set the hook, following a fish bite. This causes a delay, which often results in the fisherman losing the fish, or losing a pole and reel to a fish that runs with a baited hook. Second, accommodating stable support of the prop and pole under a variety of conditions, such as from the shore, in a boat and above a layer of ice has been problematical, since no one prop suits all conditions. Third, a variety of pole props or holders, including various pole receivers and different land, ice and boat anchors or bases have not been collectively and individually available from a single source, making preparation for and the fishing event frustrating for avid and dedicated fisherman.

### BRIEF SUMMARY AND OBJECTS OF THE INVENTION

In brief summary, the present invention addresses and solves the problems of prop fishing mentioned above. Fishing pole holders are provided, which automatically set a hook in the mouth of a fish directly in response to a fish bite, without human intervention. A plurality of stable supports for props or holders and a fishing pole are provided to facilely accommodate fishing under a variety of conditions, including shore fishing, boat fishing and ice fishing. The present invention also comprises a kit comprising a portable container or carrying case in which a fisherman is able to carry a plurality of pole holders comprising automatic hook setters, and several anchors or bases for supporting the pole holders to accommodate, from a single source, shore, boat and ice fishing, as well as ancillary items to accommodate use of props or holders equipped with automatic hook setting mechanisms.

In view of the foregoing, it is a primary object of this invention to solve problems heretofore associated with fishing pole holders.

Another paramount object is the provision of a kit or common source for storing and transporting a variety of fishing pole holders and ancillary equipment for shore, boat and above ice fishing.

Another valued object is the provision of a plurality of fishing pole holders or props, each equipped with a mechanism by which a hook is automatically set in the mouth of a fish by reason of a fish bite.

These and other objects and features of the present invention will be apparent from the following detailed description taken with reference to the accompanying drawings.

### BRIEF DESCRIPTION OF THE DRAWINGS

FIG. 1 is a perspective of one presently preferred portable kit comprising a common source of holders and accessories to accommodate propping any one of several fishing poles for shore, pontoon or aluminum boat and ice fishing;

FIG. 2 is a perspective of one presently preferred fishing pole holder in an at rest position, which is adapted, at its proximal end, to be embedded into the ground and to be cocked to angularly support a fishing pole for fishing;

FIG. 3 is a perspective of the fishing pole holder of FIG. 2, showing a pole and reel supported in a slotless pole receiver of the holder and further showing the proximal stake thereof embedded into the ground, with the distal receiver of the holder being in a spring-biased into angular position;

FIG. 4 is an exploded perspective of the fishing pole holder of FIGS. 2 and 3;

FIG. 5 is a perspective of a rectangular, ground-supported or ice supported base, by which the remainder of a holder, according to the present invention, may be supported;

FIG. 6 is a perspective of the base of FIG. 5, equipped with the holder of FIG. 2, exclusive of the stake, in removable receipt of a fishing pole and reel, and wherein the base is held down by a rock.

FIG. 7 is a perspective of an extender attachment by which a holder, according to the present invention, may be mounted, to elevate the holder thus allowing a fisherman to more easily reach a fishing pole supported by the holder, when the fisherman is standing or seated in a chair;

FIG. 8 is a perspective of another tubular pole-receiver of a holder, according to the present invention, into which a pole may be inserted and rotated so that a reel attached to the pole prevents inadvertent linear removal accommodating a fly fishing pole with a left hand reel;

FIG. 9 is a perspective of a curvilinear anchor, shown mounted to a tubular part of a pontoon boat, to which a holder, according to the present invention, may be connected for pontoon boat fishing;

FIG. 10 is a perspective of another anchor adapted to be clamp-fastened to the exposed edge or rail of an aluminum boat and to which a holder, according to the present invention, may be attached, for boat fishing as well as to a bucket for ice fishing; and

FIG. 11 is a perspective of a slotted tubular fishing pole receiver for use with an ice fishing pole as part of a holder, according to the principles of the present invention.

### DETAILED DESCRIPTION OF THE ILLUSTRATED EMBODIMENTS

The present invention addresses and solves problems of the prior art in the realm of fishing from the shore, from a boat or through a man-made hole in a layer of ice covering a body of water. These problems include, but are not limited to: provision of a mechanism which automatically sets a hook in the mouth of a fish directly in response to a fish bite; making available from a single source for a plurality of props or holders, the source being a kit in the form of a portable container; and a variety of props or holders by which a fishing pole is held facilely to accommodate fishing under a variety of conditions, including shore fishing, boat fishing and ice fishing. By providing a kit containing everything needed for such fishing under any set of circumstances, the fisherman is able to readily pick and choose between fishing pole props and holders and related items instantaneously and without the need to search for such items or be disappointed because some were left home.

Fishing kits according to the present invention, as mentioned above, comprise a portable container, the interior of which stores a plurality of removably stored fishing pole holders, each having a hook setting mechanism by which a fish bite automatically sets a hook in the mouth of the fish. Each holder is attached to a base or anchor by which the associated holder, with hook setting mechanism, is held in a stable fishing position, with the fishing pole poised at an angle upward to the horizontal. The anchor or base for the holders may comprise a proximately located ground-embedded or ground-engaging base, an ice-supported anchor and an attachment for connection to an aluminum boat, a pontoon boat and other buoyant vessels, as well as for use with a bucket for ice fishing.

In order to accommodate ready retrieval of a propped fishing pole, a length extender is provided by the present invention to more substantially elevated a holder so that, among other things, the fisherman may stand or rest comfortably in a chair adjacent to the holder and propped fishing pole.

Each holder comprises a pivotable receptacle or receiver for removably receiving the proximal end of a fishing pole. Below the receptacle exists a tension-applying bias mechanism and a cock and release mechanism for accommodating retention of the bias mechanism and a fishing pole in the angular fishing position by force counter to the tension bias. Release of the counter force is accommodated immediately responsive to a fish bite, causing bias mechanism to automatically set a fish hook at the end of the fishing pole line into the mouth of the fish. Among other things, the tension-applying bias mechanism may comprise a tension spring interposed between a proximal location of the pivotable receptacle and a stationary location at a central part of the holder. The cock and release mechanism may comprise contiguously engagable but releasable components, including a first component in the nature of a slender finger pivotably connected to a central part of the holder and comprising an elongated length. The finger is displaceable to a position juxtaposed the receptacle so as to be releasably contiguous with an engagement element adjacent to the central part of the holder. The releasable engagement element is carried near the proximal end of the receptacle to temporarily engage the releasable engagement element when the receptacle is in its cocked angular fishing position. The temporary engagement is released by a fish bite to cause the biasing mechanism to automatically set the hook, without human intervention.

Each of several receptacles or receivers comprise a hollow tubular body, which is either without a slot, or with a linear slot for use with ice fishing poles or with a dog leg slot, the dog leg slot accommodating linear insertion of the proximal end of a fly fishing pole followed by a rotation thereof into an enlarged retaining site in the slot, which prevents inadvertent separation, accommodating left and right hand reels.

The present invention also comprises methods of fishing with a propped fishing pole, by which fishing occurs from a shore, from a boat and through a hole in a layer of the ice. The method includes removably inserting the proximal end of the fishing pole into a pole-receiving receptacle located at the distal end of the fishing pole prop. The method also includes rotationably cocking the pole-receiving receptacle at an angle to the horizontal, counter to the force of a bias, for example from a tension spring, imposed against the trailing end of the receptacle, while temporarily preventing rotational displacement of the receptacle responsive to the force of the bias, using a restraint element. Initially, both the fishing pole and the prop are supported in a stable way upon a base or anchor associated with or upon the ground, or with a boat, or in respect to a layer of ice. The pole-receiving receptacle is released from its cocked position responsive to a fish bite to automatically set the fishing hook into the mouth of the fish. This is done by releasing the restraint element, thus allowing rotation of the receptacle due to the force of the bias.

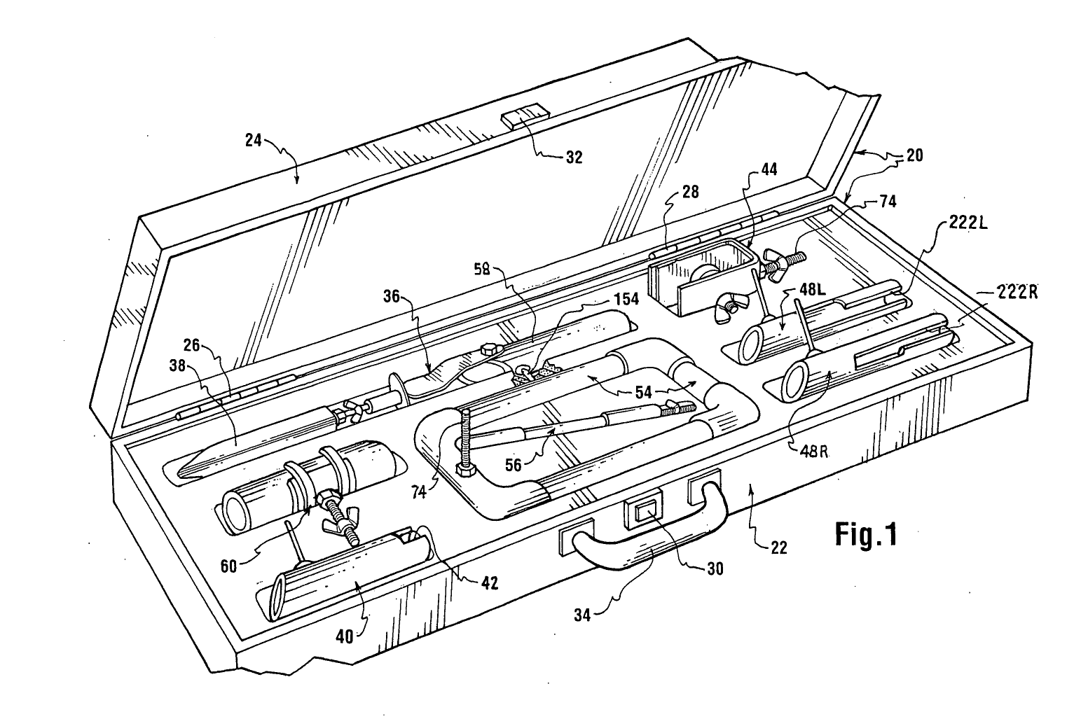

Reference is now made to the drawings, wherein like numerals are used to designate like parts throughout. FIG. 1 illustrates a kit, generally designated 20, in accordance with the principles of the present invention. While only one type of container is described, any suitable container may be used to create the kit. Kit 20 comprises a carrying case or container, which can be opened and closed for access to the contents or to render the closed container portable, so that it can be unitarily stored or moved from place-to-place conveniently. The container 20 comprises a bottom element, generally designated 22, and a top lid, generally designated 24. The lid 24 is hinged at sites 26 and 28 to one edge of the base 22, so that the lid may be pivotably opened, when desired, although a zipper connection could be used. Male and female latch mechanisms 30 and 32 are provided to interconnect and releaseably hold the lid in its closed position as the container is moved from place-to-place or stored. The container 20 may be carried by a conventional U-shaped handle 34. If desired, a shoulder strap for the container can be provided.

The base 22 is illustrated as comprising indentations into which a plurality of fishing props or holders and related items are stored for easy identification and retrieval by a fisherman, independent of whether the fishing site is on a shore, in a boat or above a layer of ice.

The fishing items in the base 22 of the container 20 are shown in FIG. 1. The items available in container 20 comprise a ground-supported pole holder, generally designated 36, comprising a stake 38, at the proximal end, and a non-slotted pole receiver 58, at the distal end, and a pole receiver 40 comprising a linear slot 42. While stake 38 is shown as being connected to receiver 58, it may be stored as a separate item in container 20, for selective on site connection to any of the several receivers also found in the container 20.

Also shown in FIG. 1 as being disposed within the base 22 of the container 20 is an anchor, generally designated 44, in the nature of a clamp to be secured to a top rail of an aluminum boat or mounted to an ice fishing bucket and to which a pole holder with pole receiver is to be connected to the threads 74 at the distal end.

Also shown as being contained in the base 22 of the container 20 other forms of fishing pole receivers, generally designated 48L and 48R, which comprise respective slot enlargements 222L and 222R, for purposes later to be explained. The slot enlargement may extend to the left or to the right for purposes yet to be explained.

Also located in an indentation in the base 22 is a ground-engaging rectangular base or anchor generally designated 54, for holding a prop and fishing pole, in the manner explained hereinafter.

A further indentation in the base 22 contains an extender, generally designated 56, the nature and purpose of which is explained hereinafter.

A slotted pole receiver, generally designated 40, is shown in an indentation in the base, toward the lower left hand corner of FIG. 1. A further anchor or base, generally 60, to be connected to the proximal end of fishing pole holders, in accordance with the present invention and to be used in association with a pontoon boat, is shown in an indentation in the base 22.

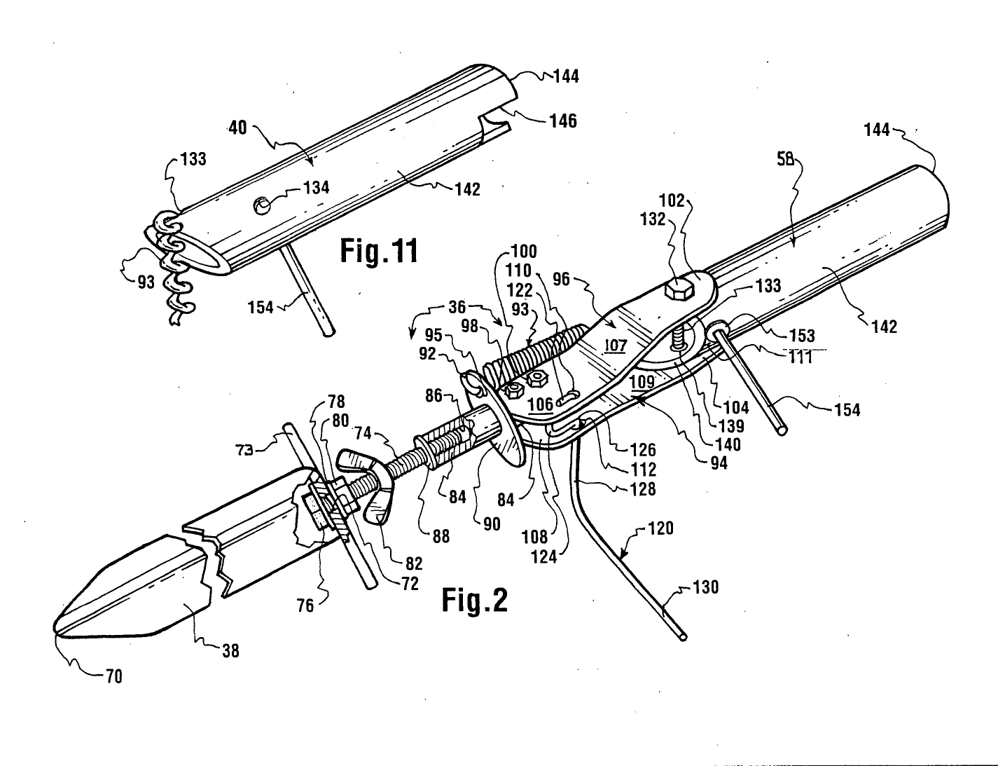

Reference is now made to FIGS. 2-4, in respect to further detail regarding holder 36. As previously mentioned, holder 36 is shown as being connected to a proximal stake 38 and a distal hollow tubular non-slotted receptacle or receiver 58. Receptacle 40 receives and supports an ice fishing pole, free from manual support by the fisherman. The stake 38 comprises a proximal point 70 and resembles a tent stake, being formed of shape-retaining synthetic resinous material or shape-retaining metal, such as steel. The distal-end of the stake 38 comprises a distal stake head 73, in the nature of a flat elongated plate, which is integrally connected to the remainder of the stake in any suitable way, such as by metal-to-metal welding. The stake head 73 comprises a central aperture 72 (FIG. 2) through which a threaded shaft 74 passes, the threaded shaft 74 forming part of a bolt comprising a head 76, the diametral size thereof being greater than the aperture 72. The bolt head 76 is disposed below the stake head 72. Inadvertent removal of the bolt comprising head 76 and threaded shaft 74 is prevented by a washer 78, placed over the shaft 74, and a threadedly connected nut 80 threaded onto threaded shaft 74, nut 80 being tightened against the washer 78. A wing nut 82 is also threaded onto shaft 74 distal of the nut 80, for a purpose to be explained below.

The distal end of the threaded shaft 74 is threaded into the hollow of a sleeve 84, which hollow has female threads 86, which match the male threads of threaded shaft 74.

Proximal of the sleeve 84 is a washer or cap 88 surrounding shaft 74 against which the wing nut 82 is tightened firmly so that the male threads of the threaded shaft 74 do not inadvertently separate from the female threads 86 at the interior of the sleeve 84, when in the fully assembled and useable condition. See FIG. 2.

The outside diameter of the sleeve 84 is shown as being of a uniform dimension. A large washer 90 centrally surrounds the sleeve 84 to anchor the lower end 92 of a tension spring 93, at aperture 95, for purposes yet to be explained.

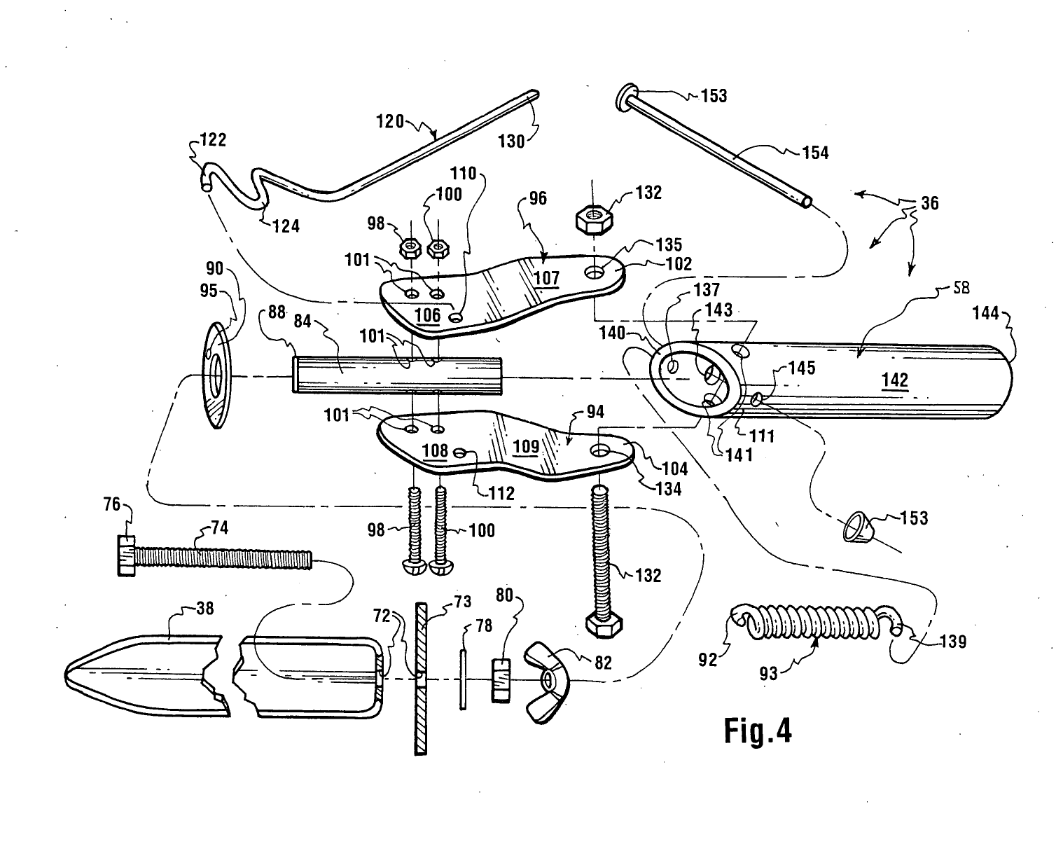

The sleeve 84 extends in a distal direction between a pair of dog leg gusset plates 94 and 96. The upper end of the sleeve 84 serves as a spacer between the two gusset plates 94 and 96, at the lower ends thereof. The plates 94 and 96 and the upper end of the sleeve 84 are stationarily held in a contiguous position by nut and bolt assemblies 98 and 100, which pass through aligned apertures 101 of the gusset plates 94 and 96 and the sleeve 84. See FIG. 4. Rivet assemblies may be used in lieu of nut and bolt assemblies. Thus, the sleeve or collar 84 and the gusset plates 94 and 96 are rigidly held together. The spacing between the upper ends 102 and 104 is greater than the spacing at the lower ends 106 and 108 to accommodate rotational attachment between the proximal end 109 of the pole receptacle 58 and the upper ends 102 and 104 of the plates 96 and 94. Thus, the plates 94 and 96 comprise sloped central transitional portions 107 and 109, respectively.

The lower ends 106 and 108 of the plates 96 and 94 comprise aligned apertures 110 and 112, through which a tortuously configured, shaped-retaining wire trip or trigger finger 120 loosely and pivotably passes. The trip finger 120 comprises a first free end 122, which passes through but is essentially perpendicular to the axis of the aperture 110. Finger 120 also comprises a U-shaped portion 124, disposed between the plates 94 and 96, which rotates responsive to a fish bite to allow the tension spring 93 to displace the receptacle 50 to set the hook in the mouth of a fish following a fish bite, as explained in greater detail hereinafter.

The U-shaped restraining portion 124 of the finger 120 connects at an angle to an elongated portion 128, which terminates in a free end 130.

A nut and bolt assembly 132 loosely passes, at its central threaded portion 133, through aligned apertures 134 and 135 in the distal portions 104 and 102 of plates 94 and 96 and spaced proximal apertures 141 in the spaced walls of the hollow tubular pole end receptacle 58. See FIG. 4. Thus, the receptacle 58 is pivotably joined to the plates 94 and 96, such pivoting being restrained against the force of tension spring 93 by the releasable engagement of rod 154 and the U-shaped part 124 of the trip finger 120, for purposes yet to be explained.

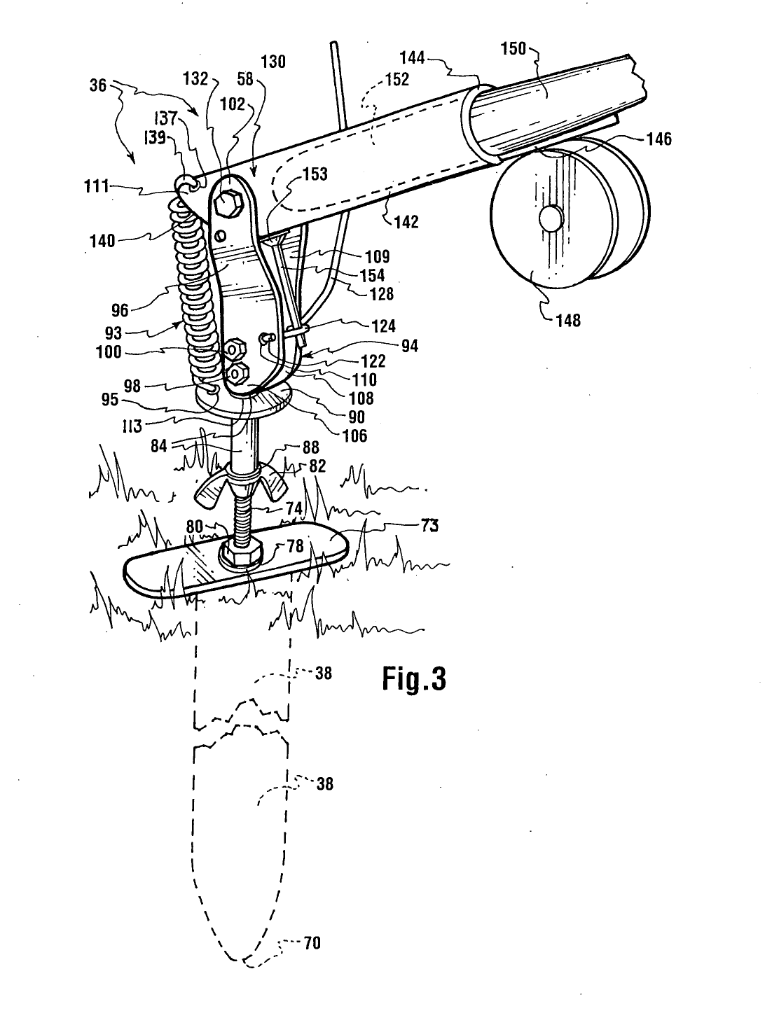

The receptacle 40 may comprise hollow polyvinyl chloride (PVC) tubing of a suitable length so as to comprise a beveled proximal end 140, a central hollow annular portion 142 and, a slotted distal edge 144. The proximal end of the pole 152 rests within the hollow interior of the central portion 142 of the receptacle 58. See FIG. 3.

A cylindrically-shaped rod 154 (FIG. 2) extends from and essentially perpendicular to the axis of the receptacle 58 for a substantial distance below the receptacle 58 for engagement with the central portion 124 of the trip finger 120 to cock the finger 120 and hold the pole 150 in its fishing position shown in FIG. 3, counter to the force of tension spring 93. The rod 154 is inserted through aperture 143 in receiver 58 so as to extend radially through and beyond aperture 145 of receiver 58. The rod 154 is non-moveably connected to the proximal end 109 of the receiver 58 by a rivet assembly 153. In lieu of rivet assembly 153, any other suitable fastener, such as a nut and bolt assembly, may be used. When a fish bite occurs, the distal tip of the pole 150 is bent and the receptacle 58 is rotated in a clockwise direction, as viewed in FIG. 3, which releases the restrained relationship between portion 124 of the finger 120 and the retaining rod 154, such that the finger 120 rotates to place the U-shaped portion 124 of the finger 120 spaced away from the rod 154. As a consequence, the bias of tension spring 90 causes the fishing pole to rotate forceably in a counter clockwise direction, as viewed in FIG. 3, to automatically set the hook in the mouth of the fish, which has taken the bait. When the fish is landed or lost from the hook, the finger 120 and the rod 154 may, once more, be manually returned to the set or cocked fishing position illustrated in FIG. 3.

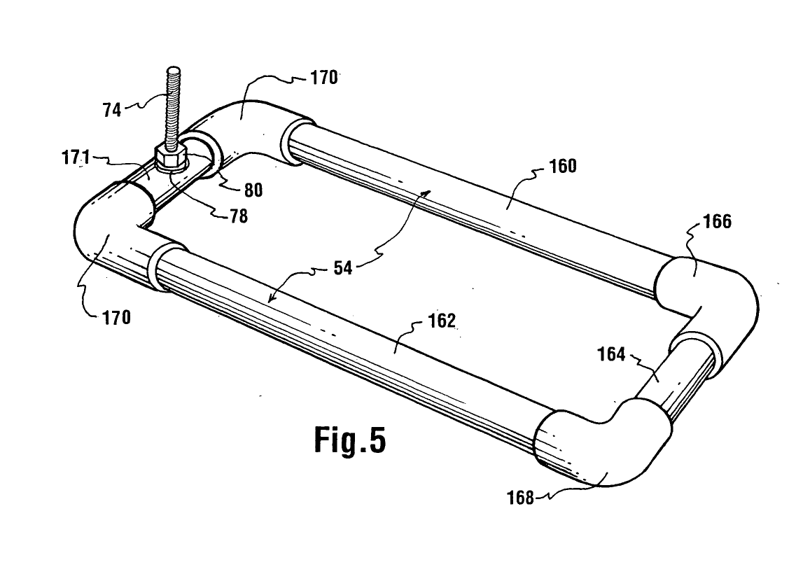

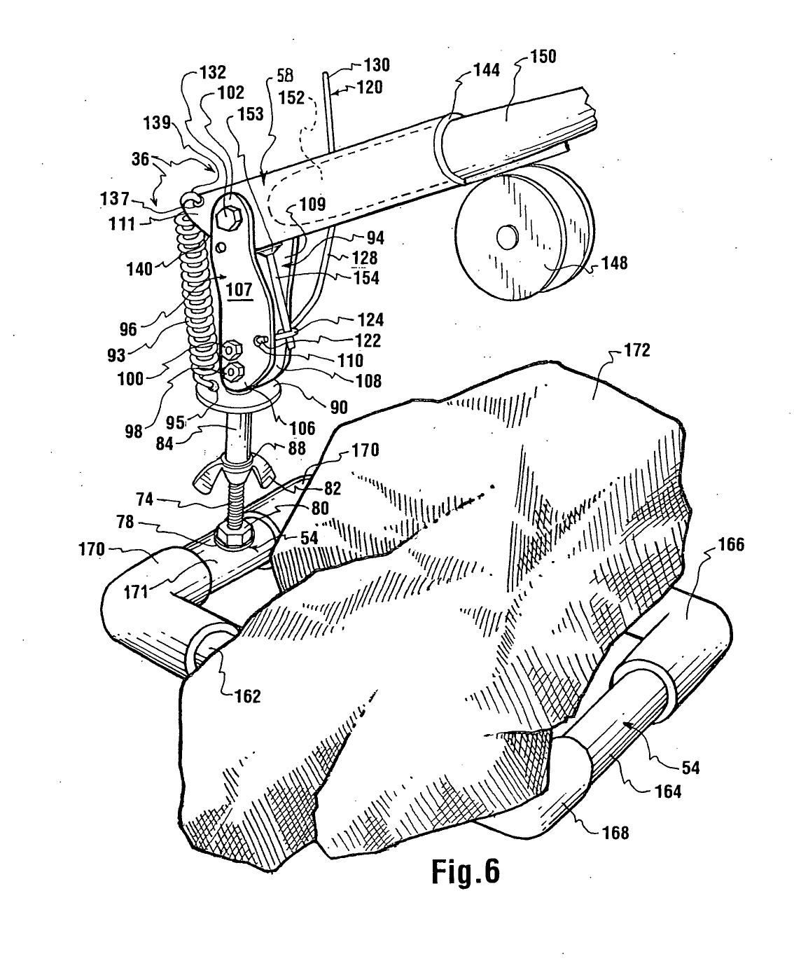

Holders, in accordance with the principles of the present invention, may be used for shore fishing in circumstances where an earth-embedded stake is not used to secure a holder. While any holder, in accordance with the principles of the present invention, may be used for other forms of ground support, the ground surface-engaging rectangular base 54 is a presently preferred embodiment. See FIG. 5. Base 54 may also be used for ice fishing. The rectangular base 54 comprises four lineal polyvinyl chloride (PVC) tubes 160, 162, 164, and 171. Using commercially available glue, one end of tube 160 is connected to one end of tube 164 by a PVC elbow 166. The one end of the tube 160 is snugly inserted into and glued to the interior of one end of elbow 166. Likewise, elbow 168 is glued to the other end of tube 164 and to one end of tube 162. Tubular elbow pieces 170 receive the other end of tubes 160 and 162 respectively and are glued in place. The other ends of spaced elbow tubes 170 receive opposite ends of tube 171 and are glued in place. Thus, the rectangular base shown in FIGS. 5 and 6 is formed.

In respect to use of base 54, a nut and bolt assembly 76 and 80 is used to cause the threads of shaft 74 to extend through and be secured in aligned centrally-located apertures in U-shaped PVC pipe 171, in the manner explained above. As seen in FIG. 6, the holder 36, absent the stake 38, is secured to the threaded shaft 74 of base 54 in the manner as explained above in connection with FIGS. 2-4. With the wing nut 82 tightened firmly against the washer 88; the holder 36 may be cocked and receive the proximal end 152 of a fishing rod 150, usually for stationary shore fishing. In some instances, the rectangular base 54 alone will provide sufficient support, as it rests on the surface of the ground or ice, to avoid base displacement of any significance when a fish bite occurs. Where larger fish are expected to be caught, a rock or other weight 172 may be placed on top of the rectangular base 54, as shown in FIG. 6.

Typically, when ice fishing, fisherman will cut an access opening in a layer of ice through which a fishing line attached to a pole, with a hook and bait on the distal end thereof, will be placed. To utilize the present invention in conjunction with such ice fishing, a holder, in accordance with the principles of the present invention, may be utilized, together with a suitable base, such as base 54.

Under some circumstances, it is or may be desirable to position one of the holders, in accordance with the present invention, in a more elevated position so as to provide more convenient access to a fisherman who is standing or is seated in a chair adjacent to the holder. In this way, the fisherman may more rapidly grasp the fishing pole for retrieval of a fish caught on a hook at the end of a fishing line carried by a fishing pole. Also, for those having medical impairments, independent of time, the fishing pole, with reel, line and hook, may be more fascily retrieved to provide more comfort to the ailing fisherman.

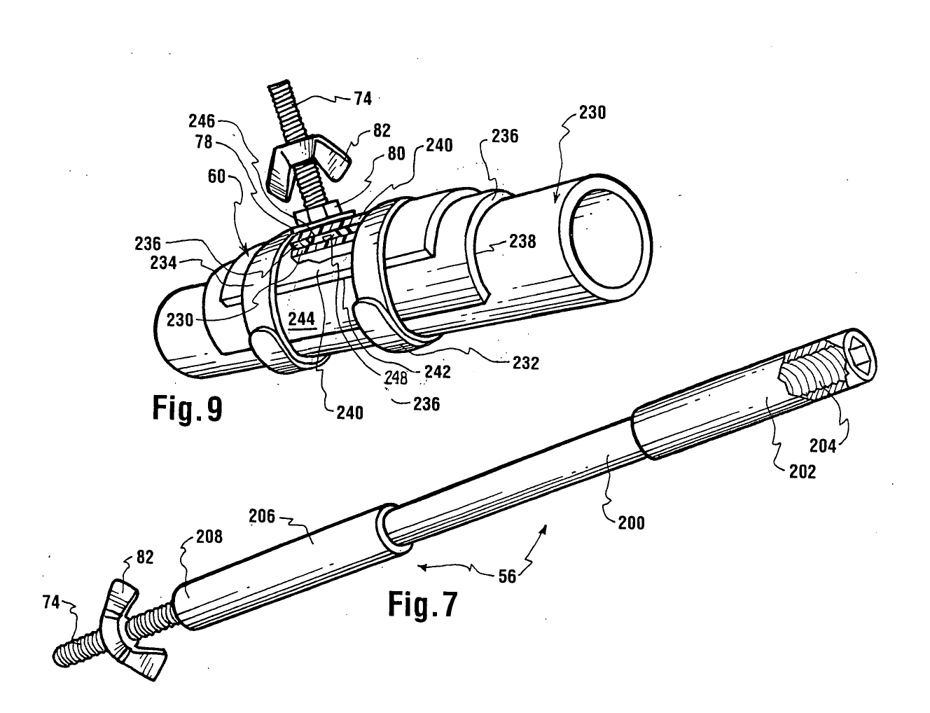

More specifically, in reference to FIG. 7, a holder may be placed in a more elevated position utilizing a linear extension 56. Extension 56 comprises a shaft or rod comprising a central linear element 200 rigidly secured, in a suitable way, to a proximal sleeve 202, which has a hollow interior comprising female threads 204. A distal collar 206 is likewise rigidly secured, in any suitable way, to the element 200, collar 206 rigidly receiving the threaded shaft 74 at the proximal end 208 thereof. A weld or indentations may be used to rigidly and immovably secure threaded shaft 74 to the end 208 of the collar 206, to prevent separation. A holder, in accordance with the present invention is secured to the exposed portion of threaded shaft 74. For example, collar 84 of the holder 36 may be threaded onto the distal end of threads 74 and, thereafter, non-rotatably secured by wing nut 82, in the manner explained above. Thus, the holder, attached to the distal end 208 of the extender 56, is positioned at a greater distance into the air to provide more rapid and more convenient access to a fishing pole held by the holder, when the extension 56 is utilized. The length of the extension 56 may be variable, to be selected by those skilled in the art, to address the circumstances and desires of those electing use the extension.

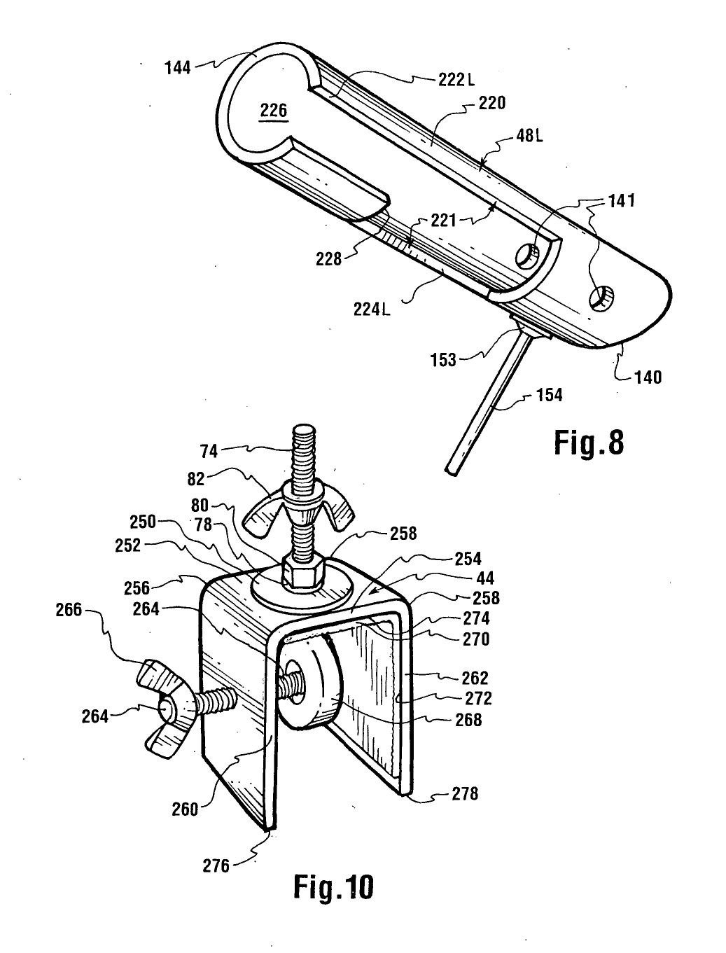

Not all fishing poles and fishing reels are dimensioned so as to be substantially identical. For example, poles used to ice fish are normally much shorter than poles used to bait fish. Bait fishing poles sometimes have a reel positioned close to the proximal end of the pole, as shown in FIGS. 3 and 6. A fly reel may be placed at various locations on the proximal end of a fishing pole, depending on the make and model of the fly pole. Sometimes it is desirable to not only utilize a slot in a fishing pole receiver, such as slot 146 of receiver 40, but also to provide an L-shaped offset, so that, upon insertion of the pole and reel into the receiver, the reel and pole may be rotated to place the reel in the L-shaped enlargement of the slot to prevent linear removal. Such a pole receiver is illustrated in FIG. 8 and generally designated 48L. The lower or proximal end of receiver 48 is essentially identical to the proximal end of receiver 40 and has been so enumerated in FIG. 8. The distal end of the receiver 48 is blunt at edge 144, which is disposed at a 90 degree angle to the axis of the receiver tubing 48. The distal edge 144 and the central portion 220 of the receiver 48 are interrupted by a L-shaped slot 221. One leg 222L of the slot 221 is essentially lineal and radially offset from but parallel to the axis of the receiver 48L. A second slot leg 224L is also radially offset but parallel to the axis of the receiver 48L and constitutes an enlargement of the leg 222L, thereby accommodating removable insertion of the fishing pole at the distal end of the hollow 226 of the receiver 48L so that the reel is aligned with and rotated into the slot enlargement 222L. Thus, inadvertent linear displacement of the pole and reel is prevented by engagement of the reel with an abutment surface 228. Yet, the fishing pole with reel attached may be readily removed from the receiver 48L by rotating of the reel into alignment with the slot leg 222L, followed by linear removed from slot by 222L.

The L-shaped slot 221 of FIG. 8 is enlarged to include the slot enlargement 224L, extending circumferentially in one direction, which best serves a person using his or her left hand to rotate the associated fishing reel. Receiver 48R (FIG. 1) accommodates a person using his or her right hand to rotate the reel. The slot of receiver 48R is enlarged in the opposite circumferential direction of receiver 48L, to best serve one who turns the reel with his or her right hand. Alternatively, the slot enlargement may be in both circumferential directions.

Receivers in accordance with the principles of the present invention may be adapted for use by a fisherman while in a boat, including both troll fishing and stationary fishing, of any applicable type. To do this, a holder must be mounted to the boat using a suitable connector, anchor or clamp. With reference to FIG. 9, a pontoon boat comprises a tubular rail 230 to which a clamp or anchor may be secured. For example, the anchor, generally designated 60, may be held by annular clamps 232 and 234 tightly secured to the exterior of the tube or rail 230 of the pontoon boat. The clamps 232 and 234 may be Velcro fabric clamps or metal clamps, which encircle the opposite ends of the anchor or clamp 60 and are essentially contiguous also with some of the external surface of the pontoon rail 230. Thus, the clamp 60 is held firmly in position in superimposed contiguous relation on the rail 230, with the threaded shaft 74 extending in an upward direction to receive, as herein earlier explained, a pole holder consistent with the principles of the present invention.

The anchor clamp 60 comprises a semi-annular first layer 236, having an inside circular surface 238, the diameter of which is essentially the same as the outside diameter of the pontoon rail 230. Thus, surface 238 is annularly contiguous with the external surface of the rail 230.

A second curved segment 240 is contiguously mounted centrally over the semi-annular element 236 so that the inside surface 242 of the element 240 is contiguous with the outside surface 244 of the element 236. Surfaces 242 and 244 are contiguously secured one to the other against inadvertent separation or displacement, in any suitable way, such as by use of an appropriate adhesive.

A counterbore 246 extends from the inside outwardly through aligned apertures in the walls of the elements 236 and 246, as shown in FIG. 9. A tapered head 248 is contiguously positioned in the counterbore 246 and is the integral with the proximal end of the threaded shaft 74. Thus, the threaded shaft 74 is held in an erect position for receipt of a holder in accordance with the principles of the present invention, as described above.

Reference is now made to FIG. 10, which illustrates an additional way in which holders in accordance with the principles of the present invention may be boat-secured. Specifically, the anchor or clamp 44 utilizes the previously described threaded shaft 74 secured rigidly to the upper part of the clamp 44 in essentially the same way as described in conjunction with FIG. 2. This connection of threaded shaft 74 has been enumerated in FIG. 10 as per FIG. 2. Clamp 44 is generally of an inverted U-shape, as shown with clarity in FIG. 12, with an enlarged washer 250 also tightly interposed between the washer 78 and the top surface 252 of the clamp 44. The top 252 of the clamp 44 is integrally joined at corners 256 and 258 to spaced side walls 260 and 262. The space between the side walls 260 and 262 is selected to accommodate clamping over a top rail of an aluminum boat. To this end, a threaded shaft 264 extends in threaded relation through a threaded aperture in or in association with the wall 260. A wing nut 266 is non-rotatably joined, as by welding, to the outside proximal end of the threaded shaft 264. Thus, when wing nut 266 is rotated, the threaded shaft 264 is correspondingly rotated to move the threaded shaft in a forward or a reverse direction in respect to the hollow interior of the clamp 44.

An annular cushion 268 is non-rotatably mounted to the interior distal end of the threaded shaft 264, so that when the wing nut 266 is rotated clockwise the cushion or pad 268 is advanced and tightened against the exposed rail of the aluminum boat and, when so tightened, will securely fasten the clamp 44 to the boat. Interior surfaces 270 and 272 are covered by a suitable padding 274, such as carpet, which likewise cushions the clamp against the rail of the aluminum boat.

The spaced side walls 260 and 262 of the U-shaped clamp 44 each terminate in blunt edges 276 and 278. When a holder, in accordance of the principles of the present invention, is secured to the threaded shaft 74, with the clamp 44 secured to the boat, a fisherman may fish either with the boat moving or stationary. Clamp 44 may also be used with a bucket to accommodate ice fishing.

Reference is now made to FIG. 11, which illustrates non-slotted pole receiver, generally designated 58, in accordance with the present invention. The pole receiver 58, as mentioned, is without a slot and is otherwise constructed to be identical or substantially identical to the receiver 40, illustrated in FIG. 2. Thus, non-slotted receiver 58 comprises a distal blunt edge 144, perpendicular to the axis of the receiver 58, a central annular body 142, an attached finger-holding and release rod 154, a proximal beveled edge 140, opposed but aligned pivot bolt-receiving apertures 134 and a spring end receiving aperture 133. The slotless pole receiver 58 is essentially utilized in the same way as the receivers explained above, but with a reel at the proximal end of a fishing pole disposed beyond the edge 144.

In respect to washers placed over a threaded shaft and disposed adjacent to a nut, as set forth above, such washers are preferably lock washers. In lieu of lock washers, a suitable adhesive, such as Superglue, may be used.

One skill in the art may select the diameters, wall thickness and lengths of the PVC tubing described above for receivers 40, 48 and 58 as well as the tubing for base 54. Typically, receivers for ice fishing will be shorter in length than for shore and boat fishing.

The spring value for spring 93 may vary depending on the diameter and length of the tubing forming the associated pole receiver 40, 48 and 58.

The invention may be embodied in other specific forms without departing from the spirit of the essential characteristics thereof. The present embodiments, therefore, are to be considered in all respects as illustrative and are not restrictive, the scope of the invention being indicated by the appended claims rather than by the foregoing description, and all changes which come within the meaning and range of equivalency of the claims are therefore intended to be embraced therein.

What is claimed and described to be secured by Letters Patent is:

1. A fishing kit comprising:
a portable container, the interior of which comprises a plurality of removably stored fishing pole holders;
each holders comprising a hook-setting mechanism for mechanically setting a hook responsive to a fish bite;
the holders collectively comprising: at least one anchor comprises a proximal earth-penetrating anchor for insertion into the ground; at least one anchor having a proximal ground surface-contacting base; at least one anchor comprising an ice-engaging connector; and at least one anchor comprising a proximal boat attachment.

2. A kit according to claim 1 further comprising accessories removably stored in the portable container, the accessories comprising a length extender for central holder insertion to elevate the hook-setting mechanism.

3. A kit according to claim 1 wherein the hook-setting mechanism comprises a pivotable hollow receptacle for removably-receiving a proximal end of a fishing pole, a tension-applying bias mechanism and a cock and release mechanism for accommodating retention of a fishing pole in an angular fishing position by force counter to the tension bias but also accommodating release of the counter force responsive to a fish bite causing the bias mechanism to set a fish hook into the fish.

4. A kit according to claim 3 wherein the tension-applying bias mechanism comprises a tension spring interposed between a proximal location of the pivotable receptacle and a central part of the holder.

5. A kit according to claim 3 wherein the cock and release mechanism comprises contiguously engageable components comprising a first component finger pivotably connected to a central part of the holder, the finger comprising an extended length for positioning the finger juxtaposed the receptacle and a second component releaseable engagement element carried by the receptacle to temporarily releasably restrain the finger in a stationary cocked position when the receptacle is in an angular fishing orientation, the temporary engagement element being released upon a fish bite to cause the biasing mechanism to set the hook.

6. A kit according to claim 5 wherein the finger comprises an elongated shape-retaining tortuously configured wire and the releasable engagement element comprises an elongated shape-retaining rod.

7. A fishing pole holder for shore, ice and boat fishing comprising a rotatable receptacle for receiving a proximal end of a fishing pole, when the receptacle is angularly disposed, in combination with a releasably-biased hook setting mechanism, which temporarily retains the receptacle in the angular disposition during fishing, but is released to displace the receptacle and pole counter to a force of a fish bite to thereby automatically causing a fish hook to be set into a mouth of the fish.

8. A fishing pole holder according to claim 7 wherein the receptacle comprises a hollow tubular body comprising a dog leg slot into which the proximal end of a fly fishing pole is inserted linear and then rotated to prevent inadvertent separation.

9. A fishing pole holder according to claim 7 wherein the receptacle comprises a hollow annular body comprising a linear slot into which the proximal end of an ice fishing pole is inserted.

10. A fishing pole holder according to claim 7 wherein the receptacle comprises a hollow tubular body free from any slot therein into which the proximal end of the fishing pole is inserted.

11. A fishing pole holder according to claim 7 wherein the releasably-biased hook setting mechanism comprises a tension-applying bias mechanism for accommodating retention of the fishing pole and the receptacle in the angular fishing position by force counter to the tension bias and accommodating release of the counter force responsive to a fish bite causing the bias mechanism and pole to recoil thereby forcible setting the fish hook into the fish.

12. A fishing pole holder according to claim 11 wherein the tension-applying bias mechanism comprises a tension spring interposed between a proximal location of the pivotable receptacle and a central part of the holder.

13. A fishing pole holder according to claim 11 wherein the cock and release mechanism comprises contiguously engageable components comprising a first component finger pivotably connected to a central part of the holder and comprising a length extending to a position juxtaposed the receptacle, and a releasable retention element temporarily engaging and retain the finger stationary when the receptacle is in its angular fishing position, the temporary engagement being released by rotation of the retention element and the pole upon a fish bite to cause the bias mechanism to set the hook.

14. A fishing pole holder according to claim 13 wherein the finger comprises an elongated shape-retaining wire and the releasable retention element comprises an elongated shape-retaining rod.

15. A method of fishing with a propped fishing pole from a shore, from a boat and through a hole in a layer of ice comprising the acts of:
removably inserting a proximal end of a fishing pole into a two position pole-receiving receptacle located at a distal end of a fishing pole prop;
rotationally cocking the pole-receiving receptacle at an angle to the vertical and the horizontal counter to a force of a bias imposed against a proximal end of the receptacle, while temporarily preventing rotational displacement of the receptacle by the force of the bias, using a restraining element;
supporting, in a stable way, the pole prop using a proximal base;
releasing the pole-receiving receptacle from its cocked position responsive to pole and receptacle rotation caused by a fish bite to set automatically a hook in the fish caused by releasing the restraining element allowing rotation of the receptacle and the pole due to the force of the bias.
